(19) United States
(12) Patent Application Publication
(10) Pub. No.: US 2015/0004674 A1
(43) Pub. Date: Jan. 1, 2015

(54) METHOD FOR REMOVING RADIONUCLIDES USING MICROALGAE

(71) Applicant: SOGANG UNIVERSITY RESEARCH FOUNDATION, Seoul (KR)

(72) Inventors: Seung-Yop LEE, Seoul (KR); Kwang-Hwan JUNG, Gyeonggi-do (KR); Sang-Hyo LEE, Gyeonggi-do (KR); Keon Ah LEE, Incheon (KR); Ju Eun LEE, Seoul (KR); Seung Yeop LEE, Daejeon (KR)

(73) Assignee: SOGANG UNIVERSITY RESEARCH FOUNDATION, Seoul (KR)

(21) Appl. No.: 14/285,582

(22) Filed: May 22, 2014

(30) Foreign Application Priority Data
Jul. 1, 2013 (KR) 10-2013-0076717

(51) Int. Cl. A62D 3/02

(52) U.S. Cl. CPC A62D 3/02; A62D 2101/43
USPC 435/257.3; 435/262.5

(57) ABSTRACT

Provided is a method for removing radionuclides using microalgae and A composition for removing radionuclides. The method includes bring the radionuclides into contact with microalgae, and thus a method for easily removing radionuclides in eco-friendly manner is provided, and also a method for removing radionuclides with high efficiency is provided. A composition for removing radionuclides includes microalgae.

### CROSS-REFERENCE TO RELATED APPLICATION AND CLAIM OF PRIORITY

This application claims the benefit of Korean Patent Application No. 10-2013-0076717, filed Jul. 1, 2013, at the Korean Intellectual Property Office, the disclosures of which are incorporated herein in their entirety by reference.

### BACKGROUND OF THE INVENTION

1. Field of the invention

The present invention relates to a method for removing radionuclides using microalgae.

2. Description of the Prior Art

In the situation where concern about the safety of nuclear power is increasing together with the increase in radioactive wastes due to the increasing use of atomic energy, a proper handling of the radioactive waste is technically or environmentally important issue. Currently, most of low and intermediate level radioactive waste liquids have been treated with an ion exchange resin. However, the ionic exchange resin has low selectivity, and thus is not effective due to its short lifespan for radioactive waste liquid containing general chemical components (calcium, magnesium, etc.) in large quantity. Moreover, the waste ion exchange resin has low integrity in solidified waste due to its swelling at the time of solidification.

Recently, metal ion separation by using a biosorbent has been developed based on that various microorganisms (bacteria, fungi, and algae) have various types of affinity to specific metal components. Currently, commercially available microbial adsorbents for industrial wastewater treatment are AlgaSORB [1], AMT-BIOCLAIM (MRA) [2], and the like, which have been used to remove lead, gold, cadmium, zinc, and other heavy metals. Radionuclide removal by microbial adsorption has been comparatively recently researched, but has been reported to obtain excellent separating performance for particular radioactive components as compared with the ion exchange resin.

Metal component adsorption by microorganisms is selectively conducted through ion-exchange, complexation, coordination, chelation, inorganic microprecipitation, or the like. In particular, metal ion adsorption by algae is a main biosorptive action of alginic acid, which is a main component for constituting cell walls of the algae [3]. Alginic acid is present as alginate by combining with Na⁺, Mg²⁺, or the like in natural algae, and has an ion exchange reaction with metal ions.

Throughout the entire specification, many papers and patent documents are referenced and their citations are represented. The disclosures of cited papers and patent documents are entirely incorporated by reference into the present specification, and the level of the technical field within which the present invention falls and details of the present invention are explained more clearly.

### SUMMARY OF THE INVENTION

The present inventors have endeavored to develop a method for removing radionuclides in an efficient and eco-friendly manner against radioactive effluence and contamination. As a result, the present inventors have selected microalgae having strong viability against radionuclides, and established a radionuclide removal mechanism, and thus completed the present invention.

Accordingly, an aspect of the present invention is to provide a method for removing radionuclides.

Another aspect of the present invention is to provide a composition for removing radionuclides.

Other purposes and advantages of the present disclosure will become clarified by the following detailed description of the invention, claims, and drawings.

According to an aspect of the present invention, the present invention provides a method for removing radionuclides, the method including, bring the radionuclides into contact with microalgae.

The present inventors have endeavored to develop a method for removing radionuclides in an efficient and eco-friendly manner against radioactive effluence and contamination. As a result, the present inventors have selected microalgae having strong viability against radionuclides, and established a radionuclide removal mechanism.

The method for removing radionuclides according to the present invention uses microalgae.

According to an embodiment of the present invention, the microalgae are species of the genus Chlorella. An example of the species of the genus Chlorella include any one selected from the group consisting of Chlorella anitrata, Chlorella antarctica, Chlorella aureoviridis, Chlorella Candida, Chlorella capsulata, Chlorella desiccata, Chlorella ellipsoidea, Chlorella emersonii, Chlorella fusca, Chlorella fusca var. vacuolata, Chlorella glucotropha, Chlorella infusionum, Chlorella infusionum var. Actophila, Chlorella infusionum var. Auxenophila, Chlorella kessleri, Chlorella luteoviridis, Chlorella luteoviridis var. aureoviridis, Chlorella luteoviridis var. Lutescens, Chlorella miniata, Chlorella minutissima, Chlorella mutabilis, Chlorella nocturna, Chlorella parva, Chlorella photophila, Chlorella pringsheimii, Chlorella protothecoides, Chlorella regularis, Chlorella regularis var. minima, Chlorella regularis var. umbricata, Chlorella reisiglii, Chlorella saccharophila, Chlorella saccharophila var. ellipsoidea, Chlorella salina, Chlorella simplex, Chlorella sorokiniana, Chlorella sphaerica, Chlorella stigmatophora, Chlorella vanniellii, Chlorella vulgaris, Chlorella vulgaris f. tertia, Chlorella vulgaris var. airidis, Chlorella vulgaris var. vulgaris, Chlorella vulgaris var. vulgaris f. tertia, Chlorella vulgaris var. vulgaris f. viridis, Chlorella xanthella, and Chlorella zofingiensis.

According to another embodiment of the present invention, the species of the genus Chlorella is Chlorella sorokinianna or Chlorella vulgaris.

Chlorella sorokinianna or Chlorella vulgaris has strong viability against various radionuclides as well as exhibits strong radionuclide removal capability. The radionuclides include cesium (Cesium-137), strontium (Strontium-90), uranium (Uranium-238), barium (Barium-133), cadmium (Cadmium-109), cobalt (Cobalt-57), cobalt (Cobalt-60), europium (Europium-152), manganese (Manganese-54), sodium (Sodium-22), zinc (Zinc-22), technetium (Technetium-99m), thallium (Thallium-204), carbon (Carbon-14), tritium (Hydrogen-3), polonium (Polonium-210) and americium (Americium-241), but are not limited thereto.

According to an embodiment of the present invention, the radionuclide is cesium or strontium.

More specifically, the microalgae of the genus Chlorella (e.g., Chlorella sorokinianna) has strong viability against uranium, cesium, and strontium, and has radionuclide removal capability to remove 200 Bq/ml and 2000 Bq/ml of strontium by at least 40% and at least 30%, respectively. Also, the microalgae of the genus Chlorella (e.g., Chlorella vulgaris) has radionuclide removal capability to remove 2,100 Bq/ml of cesium by at least 60%, and has radionuclide removal capability to remove 200 Bq/ml and 2,000 Bq/ml of strontium by at least 80% and at least 90%, respectively.

Herein, the step of bring the radionuclides into contact with microalgae according to the present invention is performed in a buffer solution.

According to an embodiment of the present invention, the step of bring the radionuclides into contact with microalgae is performed under at pH 7.5 to pH 9.0.

More specifically, the bring the radionuclides into contact with microalgae of the present invention may include any buffer solution in the art, for example, a buffer solution of NaHCO₃, and a buffer solution containing NaHCO₃, NaNO₃, and NaCl, but is not limited thereto. The buffer solution is composed of only a basic buffer solution excluding various nutrient salts. Excessive nutrient materials and other ions may be decisive factor in analyzing adsorption and uptake of radionuclides by microalgae, and may react with various elements in the solution, causing precipitation of radionuclides, and thus unnecessary components are excluded.

According to another aspect of the present invention, the present invention provides a composition for removing radionuclides, the composition containing microalgae.

Since the composition of the present invention has similar contents as the method for removing radionuclides of the present invention, descriptions of overlapping contents between the two will be omitted to avoid excessive complication of the specification due to repetitive descriptions thereof.

Features and advantages of the present invention are summarized as follows:

(a) The present invention provides a method for removing radionuclides, the method including bring the radionuclides into contact with microalgae.

(b) The present invention provides a method for removing radionuclides in an eco-friendly and convenient manner.

(c) The present invention provides a method for removing radionuclides with high efficiency.

### BRIEF DESCRIPTION OF THE DRAWINGS

The above and other objects, features and advantages of the present invention will be more apparent from the following detailed description taken in conjunction with the accompanying drawings, in which:

FIGS. 1a to 1d are graphs showing numbers of microalgae cells according to radionuclides (uranium, cesium, and strontium) and their concentrations. FIGS. 1a to 1d illustrate numbers of cells of Chlorella sorokiniana, Chlorella vulgaris, Dunariella tertiolecta, and Spirulina platensis, respectively. The initial concentrations of cells were 2×10⁶ cells/ml for Chlorella sorokiniana, 1×10⁶ cells/ml for Chlorella vulgaris, 3.3×10⁶ cells/ml for Dunariella tertiolecta, and 3.3×10⁶ cells/ml for Spirulina platensis, respectively;

FIG. 2 is a graph showing the radioactive cesium (Cesium-137) removal rate according to microalgae at the initial radioactivity concentration of 2,100 Bq/ml;

FIGS. 3a and 3b are graphs showing the radionuclide strontium uptake rates of Chlorella sorokiniana and Chlorella vulgaris for the radioactive strontium (Strontium-90) at the initial radioactivity concentrations of 200 Bq/ml (FIG. 3a) and 2000 Bq/ml (FIG. 3b);

FIGS. 4a and 4b are graphs showing the radionuclide uranium uptake rates of Chlorella sorokiniana and Chlorella vulgaris at the initial radioactivity concentrations of 1.0 μM (FIG. 4a) and 1.0 μM (FIG. 4b);

FIG. 5 is a scanning electron microscopy (SEM) image of Chlorella vulgaris;

FIG. 6 shows a cesium sorption image (treatment with 5 mM cesium) of Chlorella sorokiniana observed by a scanning electron microscope, and EDS (chemical analysis) results thereof;

FIG. 7 shows a cesium sorption image (treatment with 5 mM cesium) of Chlorella vulgaris observed by a scanning electron microscope, and EDS (chemical analysis) results thereof;

FIG. 8 shows scanning electron microscopy images and EDS (chemical analysis) results of Chlorella vulgaris during strontium sorption and removal;

FIG. 9 is a transmission electron microscopy image showing the strontium reaction and radionuclides enriched on the surface of Chlorella sorokiniana;

FIG. 10 is a transmission electron microscopy image showing the strontium reaction and radionuclides enriched on the surface of Chlorella vulgaris: and

FIG. 11 is summarized the pre-treating procedure of samples to observe a transmission electron microscopy.

### DETAILED DESCRIPTION OF THE PREFERRED EMBODIMENTS

Hereinafter, the present invention will be described in detail with reference to examples. These examples are only for illustrating the present invention more specifically, and it will be apparent to those skilled in the art that the scope of the present invention is not limited by these examples.

### EXAMPLES

Materials and Methods

Microalgae Selection

In order to select microalgae useful for adsorption of radioactive substances and heavy metals, viabilities of four microalgae (Chlorella vulgaris; CV, Chlorella sorokinianna; CS, Dunariella tertiolecta; DT, and Spirulina platensis; SP) according to the radiation intensity were evaluated using radionuclides cesium (Cs-137), strontium (Sr-90), and uranium (U), by the Korea Atomic Energy Research Institute. Through this, microalgae resistant to radionuclides were confirmed. In addition, their radionuclide removal rates were observed. In order to verify the strontium removal rate, the radionuclide adsorption rates in microalgae were analyzed by β-ray assay. The cesium adsorption rates in microalgae were analyzed by γ-ray assay, and the uranium adsorption rates were analyzed by inductively coupled plasma mass spectrometry (ICP-MS).

Cell Counting

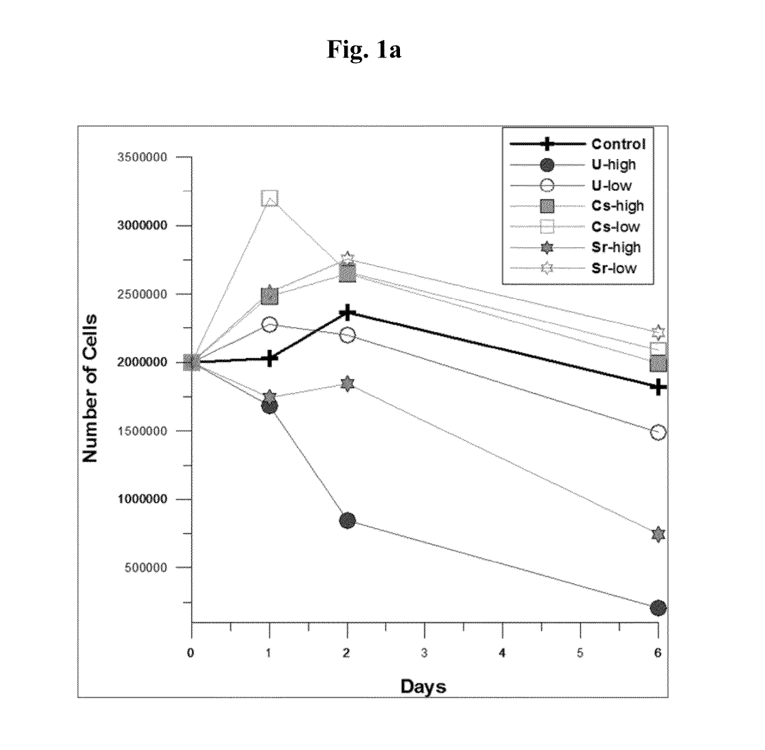

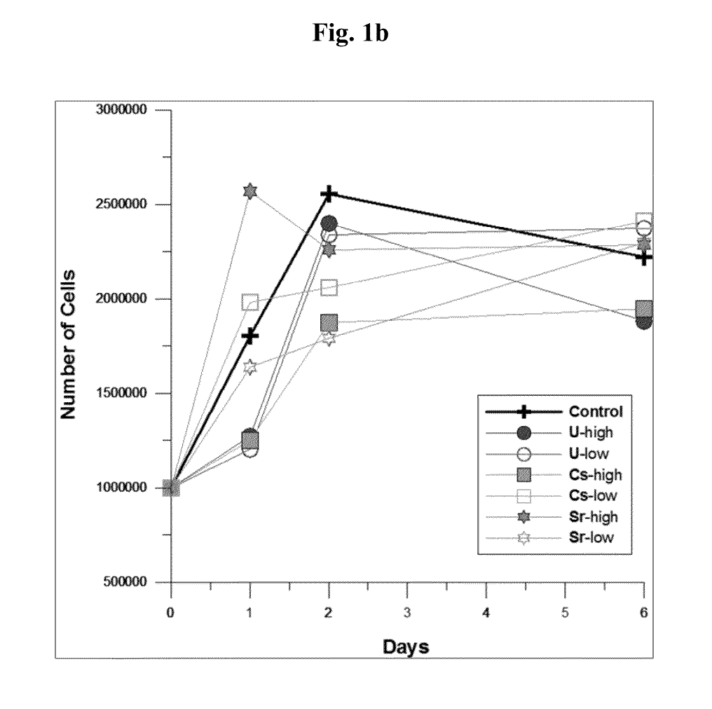

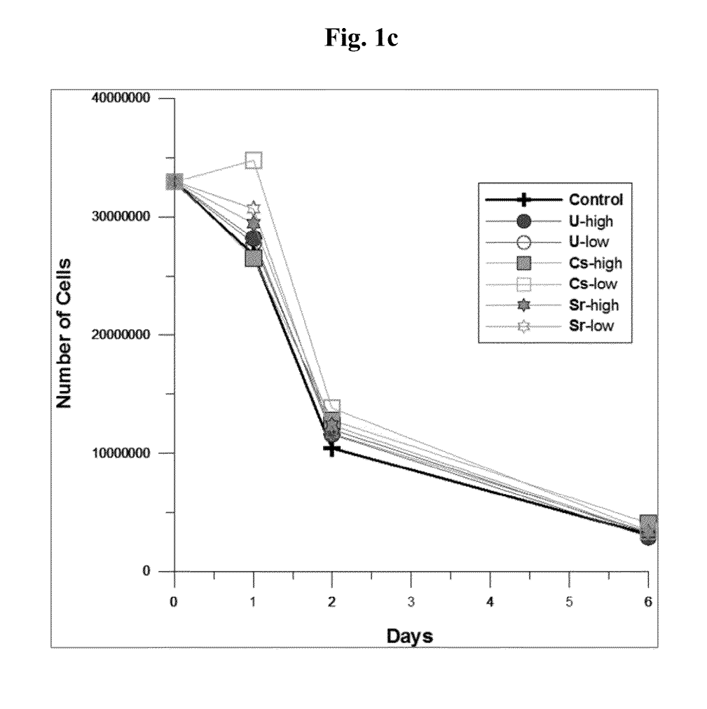

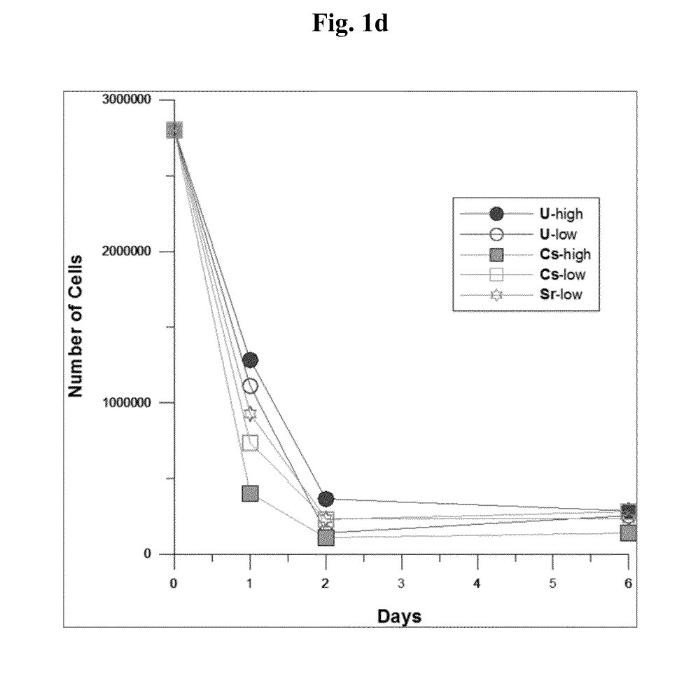

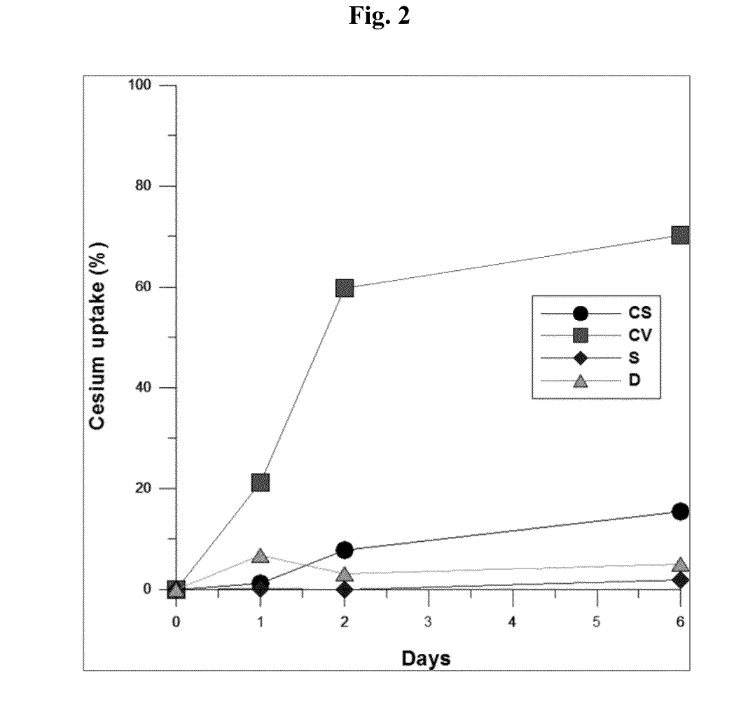

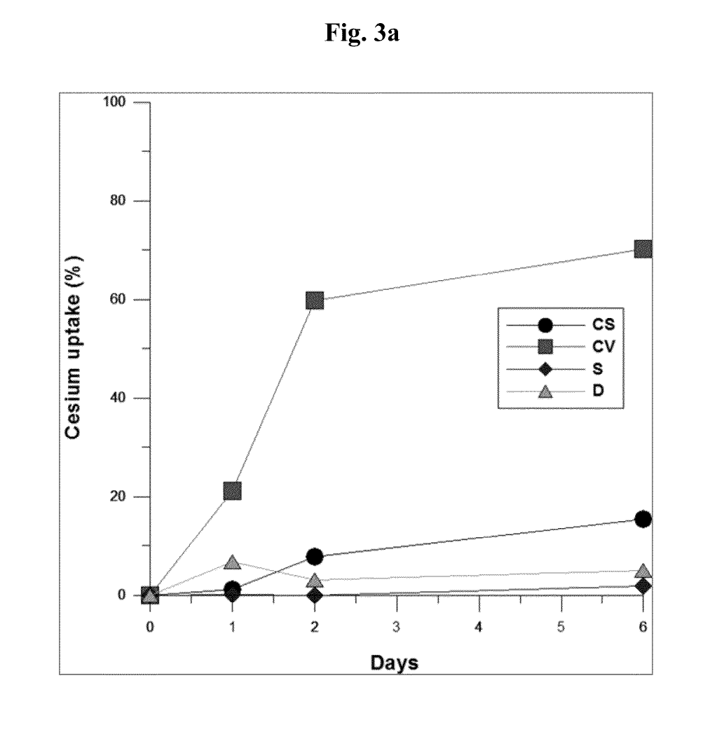

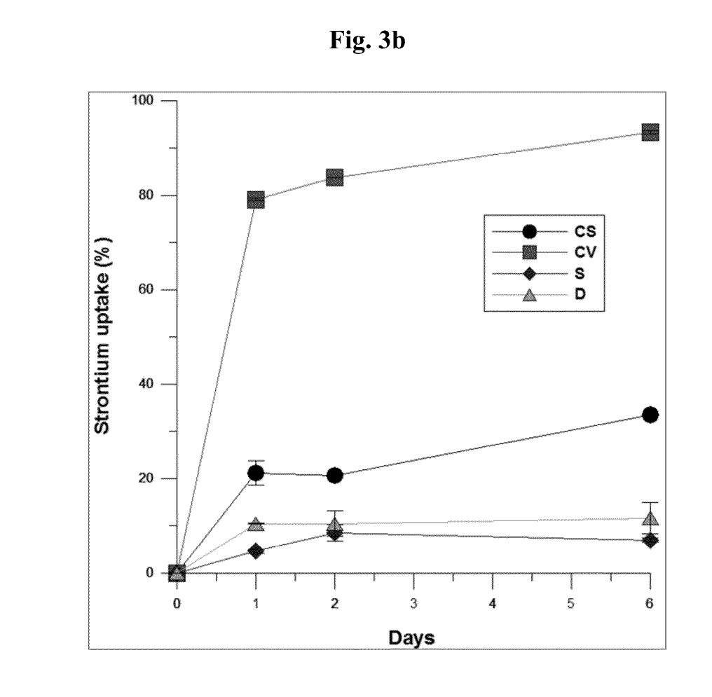

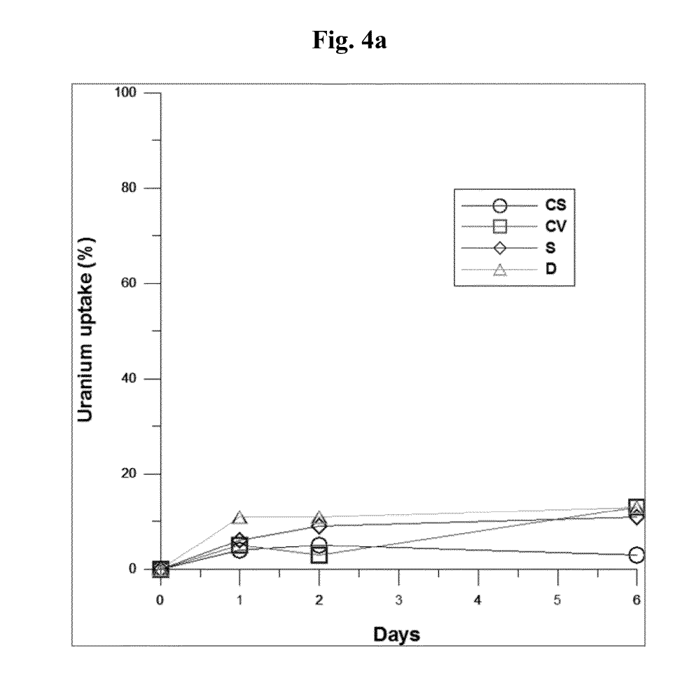

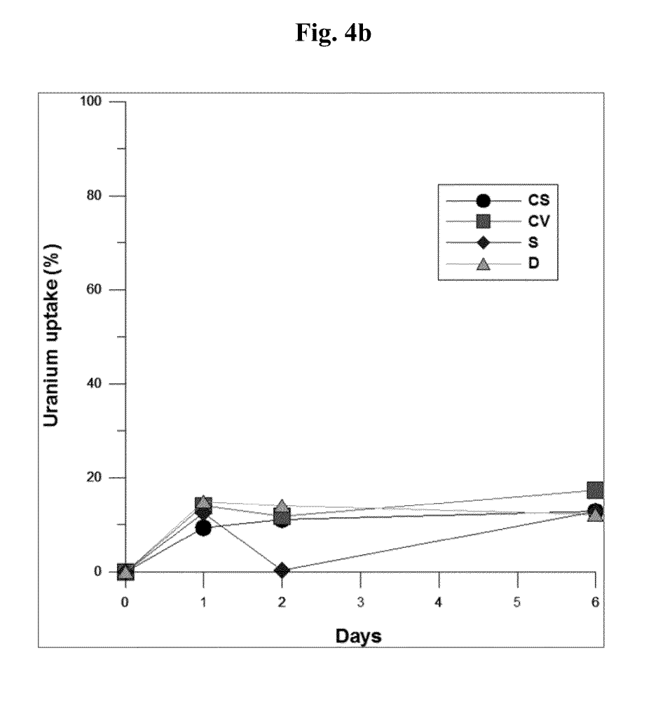

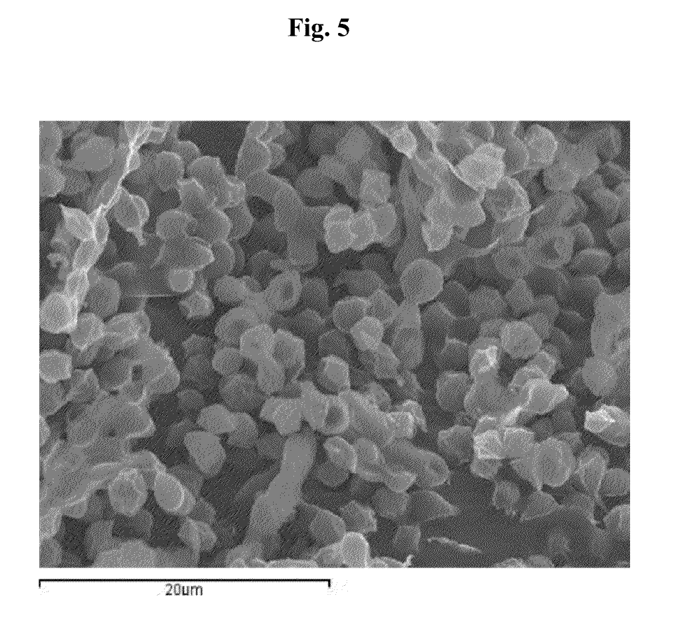

After each of respective different microalgae was cultured in a liquid nutrient medium, the culture medium was washed at least three times with a buffer containing the least ions to remove nutrient salts, and then stored in a buffer solution, for the experiment on radionuclide removal capability. The cultured microalgae were diluted to 1/10 or 1/100 for use. The initial number of injected cells and the number of cells according to the time were measured by UV/Vis spectroscopy (FIG. 1). The number of cells was determined by the relationship between the concentration of population and intensity of UV/Vis absorption spectrum. The UV measurement was conducted at about 690 nm for CS and CV microalgae, and at 680 nm for S and D microalgae. The initial cell numbers were 2×10⁶ cells/ml for Chlorella sorokiniana, 1×10⁶ cells/ml for Chlorella vulgaris, 3.3×10⁶ cells/ml for Dunariella tertiolecta, and 3.3×10⁶ cells/ml for Spirulina platensis, respectively.

Radioactivity Analysis

Among three radionuclides used as radioactive substances, that is, cesium, strontium, and uranium, radioactivity values of cesium and strontium were analyzed by using a γ-ray analyzer and a β-ray analyzer. 1 ml and of the reaction solution was collected at 1-hour intervals using a syringe and filtered through a 0.2-μm filter, and then diluted with 3 ml and of distilled water for strontium or 9 ml and of distilled water for cesium. After that, the radionuclide precipitation was prevented by the addition of nitric acid. In order to analyze radioactivity of each liquid sample, the calibration curve of the standard sample was prepared. For the radioactivity measurement of a sample, the sample was exposed to the measurement device, and its γ-ray or β-ray was detected by a detector and quantified by comparison with the standard sample. The reaction between microalgae and radionuclides was repeated two times, and the radioactivity for each time was measured. The measurement values were averaged. For uranium, 1 ml and of the reaction solution was collected at 1-hour intervals using a syringe and filtered through a 0.2-μm filter, and then the uranium concentration was analyzed by the inductively coupled plasma mass spectrometry (ICP-MS).

Scanning Electron Microscopy (SEM) Analysis

After the reaction between microalgae and radionuclides was completed, the reaction solution was centrifuged at 4000 rpm (10 min) to separate solid and liquid from each other. The microalgae precipitate was freeze-dried, and then stored at room temperature (approximately 25° C.), followed by scanning electron microscopy (SEM) analysis. The FE-SEM (Hitachi, S-4700) was used to observe shapes and features of microalgae and other precipitates. The sample prepared under atmospheric conditions was uniformly rubbed on a carbon tape attached a holder. Then, under vacuum conditions, OsO₄ was sprayed to form a thin coating (˜10 nm) on the sample, which was then observed.

Transmission Electron Microscopy (TEM) Analysis

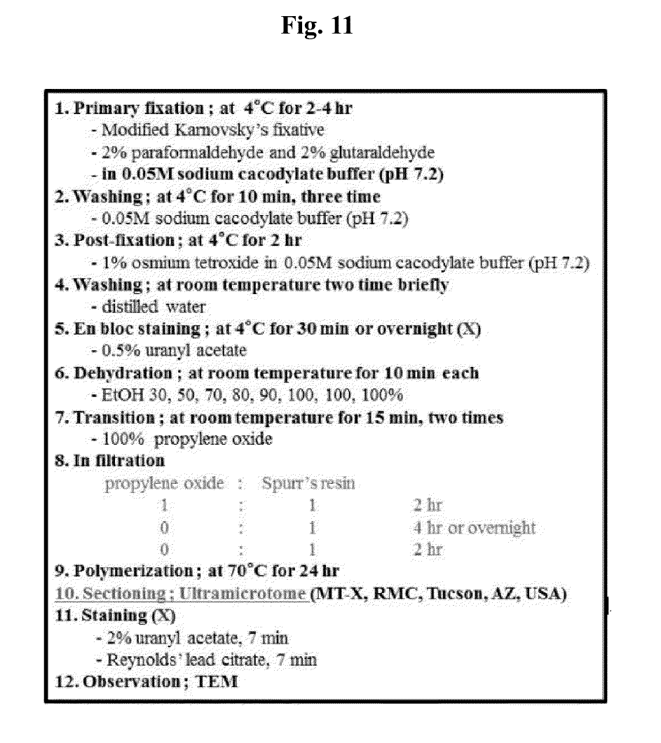

After the reaction between microalgae and radionuclides was completed, the reaction solution was centrifuged at 4000 rpm (10 min) to separate solid and liquid from each other. The precipitated microalgae were fixed and stained, and then solidified with Spurr resin. Then, the sample was cut into a thickness of 50 to 70 nm using an ultrafine slice cutter. The detailed pre-treating procedure was summarized in FIG. 11. The sample prepared through this procedure was placed on a carbon-coated 200-mesh Cu-grid, and then observed using TEM. The sample was observed using JEOL JEM 2100F (Japan) as an electron microscope at an accelerated voltage of 200 kV. In addition, for the analysis of chemical components of the sample, an Oxford EDS attachment was used.

Selection of Medium for Microalgae Culture

2 g/L of Spirulina platensis AP-20590 purchased from Korea Research Institute of Bioscience and Biotechnology was seeded in 100 ml and of SOT medium, and then stirred and cultured under conditions of 120 rpm, 30° C.±1, pH 9.0, and 50 μmol m⁻²S⁻¹ [660 nm, 12-hour light/12-hour dark cycle]. Chlorella sorokiniana was serially diluted and subcultured to a final concentration of 1% in yeast extract-peptone-glucose (YPG) medium, and stirred and cultured under conditions of 120 rpm, 30° C.±1, pH 7.5, fluorescent light at 50 μmol m⁻²S⁻¹, and 24-hour light. D-medium was used for Dunariella tertiolecta, which require high NaCl concentration (170 mM to 1.5 M) due to the nature of marine microalgae. The culture liquid was serially diluted and subcultured to have a final concentration of 1%, and stirred and cultured under conditions of 120 rpm, 25° C., pH 7.5, fluorescent light at 50 μmol m⁻²S⁻¹, and 24-hour light. The optimum NaCl concentration corresponded to 420 mM NaCl.

The solution for allowing the microalgae to react with radionuclides was composed of only a pure basic buffer solution excluding various nutrient salts. The presence of excessive nutrient materials and other ions results in difficulties in analyzing the adsorption and uptake of radionuclides by microalgae. In addition, the radionuclides may react with various elements in water, causing self-precipitation. Therefore, unnecessary components were excluded, as possible. Through the pre-test, the components and concentration of the buffer solution for allowing microalgae survival rather than microalgae growth were determined, and these results was used to perform the reaction experiment with radionuclides.

Prior to the radionuclide removal experiment, the viability (resistance) of respective microalgae was evaluated in a mixture liquid containing radionuclides (Table 1). Herein, since the exposure of experimenters should be minimized, it is impossible to manually count cells one by one. Instead, the viability can be evaluated by measuring the OD value. Therefore, the relationship between the OD value and the number of cells needs to be obtained, and thus the relationship was measured. Since Spirulina platensis cells were difficult to count due to the cytomorphological feature, the relationship between the OD value and the number of cells cannot be determined. Therefore, the OD value corresponding to 1×10⁶ Chlorella sorokiniana cells was applied to the experiment, and thus the number of cells at OD₆₈₆=0.13 was assumed to be 1×10⁶.

TABLE 1

| | | | | Composition of |
|---|---|---|---|---|
| | | Change in | | solution for |
| | Initial cell | number of | pH | radionuclide |
| Cells | concentration | cells | change | removal experiment |
| Spirulina | 1 × 10⁶ | — | — | 160 mM NaHCO₃ |
| platensis | | | | 29.4 mM NaNO₃ |
| | | | | 17 mM NaCl |
| Chlorella | 1 × 10⁶ | ~3 × 10⁶ | 7.8-8.6 | 3 mM NaHCO₃ |
| sorokiniana | | | | |
| Chlorella | 1 × 10⁶ | ~3 × 10⁶ | 8.4-8.6 | 3 mM NaHCO₃ |
| vulgaris | | | | |
| Dunariella | 1 × 10⁶ | ~3 × 10⁶ | 7.8-8.6 | 160 mM NaHCO₃ |
| tertiolecta | | | | 29.4 mM NaNO₃ |
| | | | | 17 mM NaCl |

1) Spirulina platensis

After 0.1 g/L of Spirulina platensis strain was seeded in a medium containing NaHCO₃ (3 mM), NaNO₃ (29.4 mM), and NaCl (17 mM), the growth rate was confirmed by absorbance together with a strain grown in SOT medium as a control group. Spirulina platensis was not grown in the modified medium, like in SOT medium. Therefore, the concentration of NaHCO₃ in medium components was maintained to 160 mM, so that the growth of Spirulina platensis was maintained like in the normal medium. For the preparation of sample for the radionuclide removal experiment, the medium for Spirulina platensis was exchanged from SOT medium to medium containing 160 mM NaHCO₃, 29.4 mM NaNO₃, and 17 mM NaCl at pH 7.5. The cultured Spirulina platensis was washed three times with 30 mM NaHCO₃, followed by microscopic confirmation, and then cultured under conditions for the radionuclide removal experiment. Therefore, the minimum required ion concentrations for radionuclide removal experiment by Spirulina platensis were determined by 160 mM NaHCO₃, 29.4 mM NaNO₃, and 17 mM NaCl.

2) Chlorella sorokiniana

When two solutions, (a) a 3 mM NaHCO₃ solution and (b) a solution of 3 mM NaHCO₃, 2.5 mM NaNO₃, and 0.43 mM NaCl, were tested with respect to Chlorella sorokiniana, the change in the number of cells was not great between the two solutions (1×10⁶ cells as the initial concentration was increased by 2 to 3 times after two weeks). Thus, the 3 mM NaHCO₃ solution having lower ion intensity was used for the radionuclide removal experiment.

3) Dunariella tertiolecta

When two solutions, (a) a 3 mM NaHCO₃ solution and (b) a solution of 3 mM NaHCO₃, 2.5 mM NaNO₃, and 0.43 mM NaCl, were tested with respect to Dunariella tertiolecta, the number of cells was sharply reduced in both the two solutions. Since Dunariella tertiolecta is a marine microalgae, it requires high-concentration ions. Therefore, the minimum required ion concentrations for the radionuclide removal experiment by Dunariella tertiolecta were determined by 160 mM NaHCO₃, 29.4 mM NaNO₃, and 17 mM NaCl.

4) Chlorella vulgaris

When two solutions, (a) a 3 mM NaHCO₃ solution and (b) a solution of 3 mM NaHCO₃, 2.5 mM NaNO₃, and 0.43 mM NaCl, were tested with respect to Chlorella vulgaris, the change in the number of cells was not great between the two solutions (1×10⁶ cells as the initial concentration was increased by about 2 to 3 times after two weeks). Thus, the 3 mM NaHCO₃ solution having lower ion intensity was used for the radionuclide removal experiment.

Radionuclide Removal by Microalgae

50 ml centrifugal tubes were filled with 30 ml of two previously prepared buffer solutions, and three radionuclides were respectively injected thereinto using a syringe filter (0.2 μm). For X-ray diffraction analysis and electron microscopic observation, non-radionuclides were used. 5 mM CsCl and 2 mM Sr(NO₃)₂ were prepared and then respectively added thereto (Table 2). After the completion of radionuclide injection, the pre-cultured and washed microalgae were injected in a predetermined amount according to the microalgae species using a syringe. The thus prepared centrifugal tubes were placed in an LED incubator, and the constant-temperature state of 30° C., 120 rpm, and 24-h light conditions was maintained for a long period of time. The experiment was conducted for 7 days, and as necessary, a predetermined amount of each solution sample was collected using a syringe. A cell-free control group was also prepared in a centrifugal tube containing each radionuclide.

TABLE 2

| Item | Contents |
|---|---|
| Microalgae | Chlorella sorokiniana (CS) |
| (four species) | Chlorella vulgaris (CV) |
| | Spirullina (S) |
| | Dunariella (D) |
| Buffer solution | NaHCO₃ 3 mM: CS, CV |
| (two) | NaHCO₃ 160 mM, NaNO₃ 29.4 mM and NaCl |
| | 17 mM: S, D |
| Radionuclides | U: 100 μM (high concentration), 1 |
| (three kinds, | μM(low concentration) |
| two types of | Cs-137: 2,100 Bq/ml(high radioactivity), |
| concentrations) | 210 Bq/ml(low radioactivity) |
| | Sr-90: 2,000 Bq/ml(high radioactivity), |
| | 200 Bq/ml(low radioactivity) |

Results

Evaluation on Viability of Specific Microalgae According to Radionuclides

As a result of the experiment on viability of microalgae selected from solutions containing high-concentration and low-concentration of cesium, strontium, and uranium as radionuclides, Chlorella sorokiniana exhibited viability equal to or more excellent than that of the control group for low-concentration uranium (1 μM) and low-concentration strontium (200 Bq/ml), high-concentration cesium (210 Bq/ml), and high-concentration cesium (2100 Bq/ml), and these results confirmed the resistance of Chlorella sorokiniana against radionuclides (FIG. 1a). Chlorella vulgaris exhibited viability similar to that of the control group for high-concentration 2100 Bq/ml strontium. Dunariella tertiolecta and Spirulina platensis were confirmed to have weak viability against radionuclides (FIG. 1b to 1d).

Measurement of Radionuclide Removal Rates of Microalgae

Radionuclide removal rates of the selected microalgae (Chlorella sorokiniana and Chlorella vulgaris) according to the radioactive intensity were measured using three radionuclides (uranium, cesium, and strontium). For the verification of strontium removal rates, radionuclide adsorption rates into microalgae were measured through β-ray analysis. The cesium adsorption rates into microalgae were measured through γ-ray analysis.

The radionuclide uptake rates according to microalgae using cesium, strontium, and uranium were measured. As a result, the radionuclide uptake rate in Chlorella vulgaris increased to 70% as compared with the cell-free control group for 2,100 Bq/ml of cesium. Also for 2,000 Bq/ml and 200 Bq/ml of strontium, the radionuclide uptake rate in Chlorella vulgaris was observed to increase up to 90%. The uranium uptake rates were not high, but the radionuclide uptake rates in Chlorella vulgaris and Dunariella tertiolecta were verified to have similar trends as compared with the initial concentrations, 100 μM and 1 μM. As a result of verification of radionuclide uptake rates in Chlorella vulgaris and Dunariella tertiolecta, it was observed that the uranium uptake rate was much smaller than the cesium uptake rate and strontium uptake rate.

Mechanism of Radionuclide Removal of Radionuclide-Reactive Microalgae Through Electron Microscopic Observation

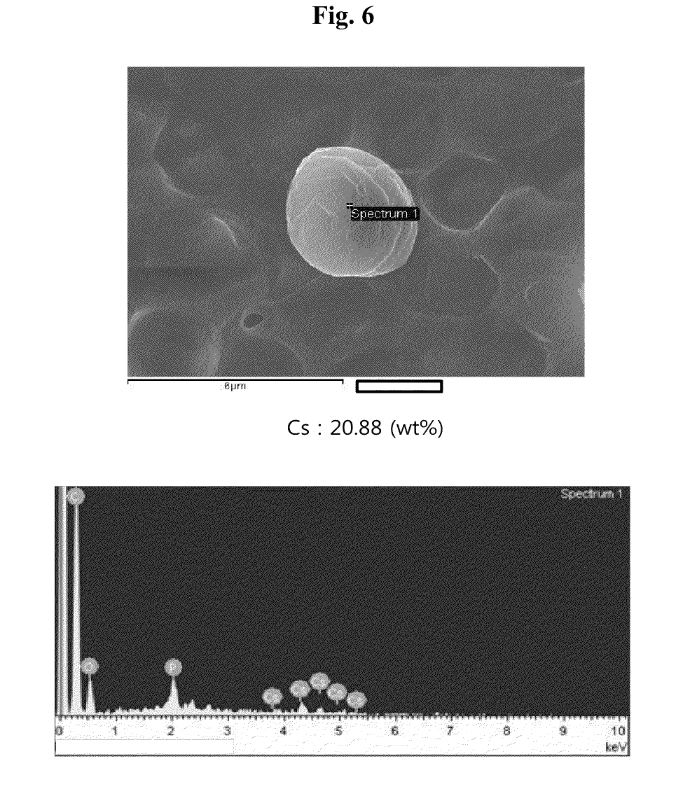

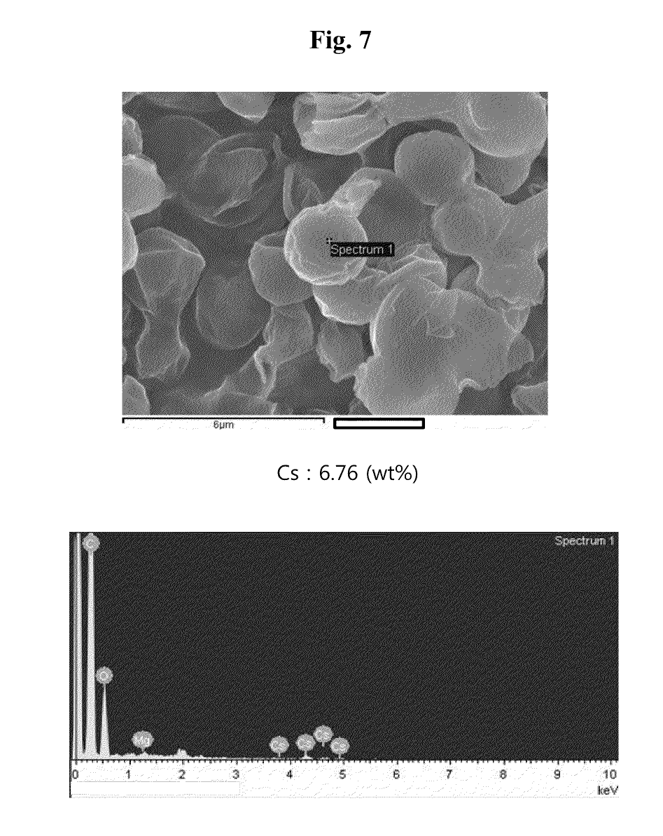

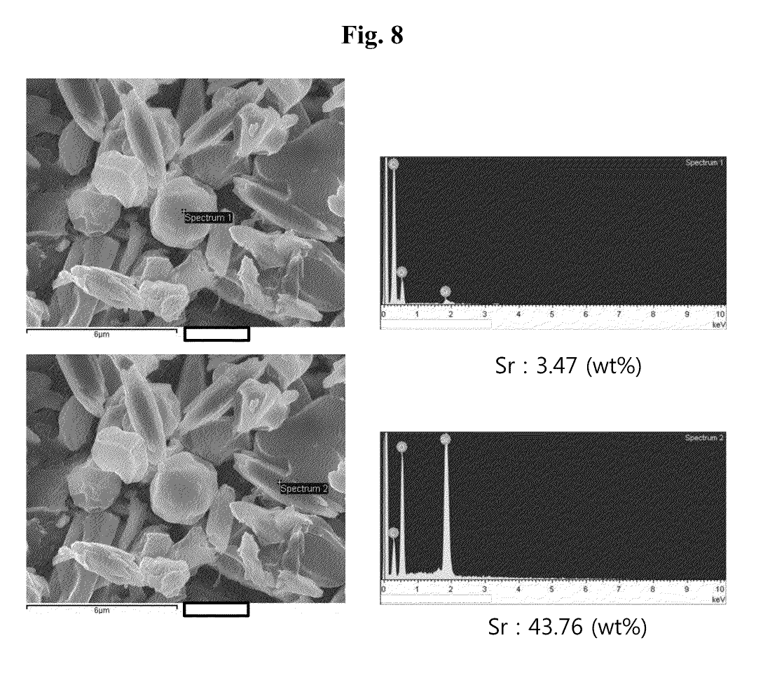

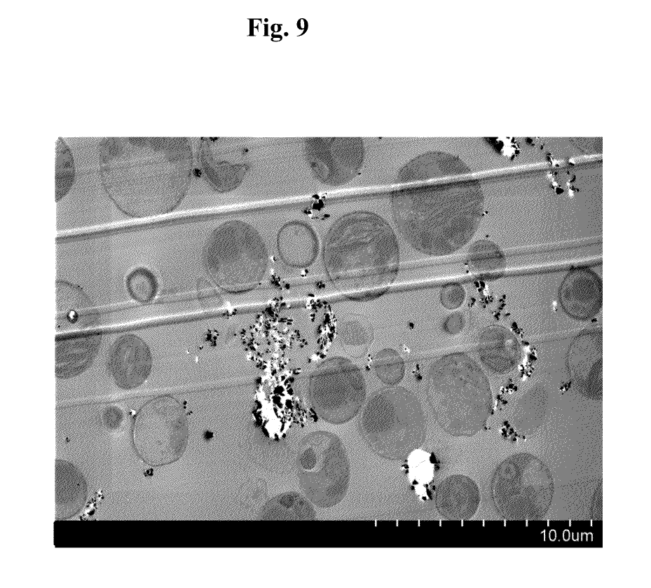

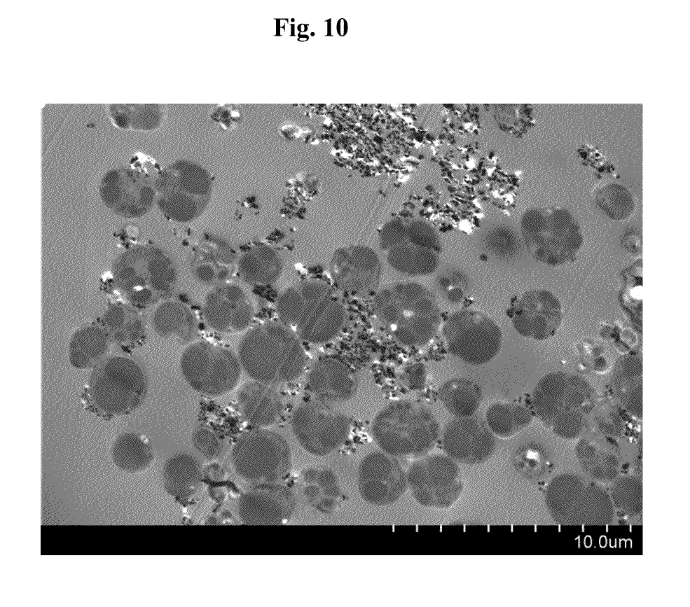

The microalgae reacting with cesium, strontium, and uranium were subjected to enrichment and pretreatment procedures, and then, for electron microscopic observation, pre-treatment to preserve the original state through freeze-drying. Specimens prepared through a specimen preparation procedure for the electron microscopic observation were observed by a scanning electron microscope. As a result, a cesium sorption of 20.88 (wt %, including 20.88 wt % of cesium based on the total weight of the specimen in dried Chlorella sorokinianna specimen) was confirmed in Chlorella sorokinianna, and a cesium sorption of 6.76 (wt %) was confirmed in Chlorella vulgaris (FIGS. 6 and 7). In the procedure of strontium sorption and removal, the strontium sorption in the sample for Chlorella vulgaris was confirmed to be 3.47 (wt %). Unusually, Chlorella vulgaris was observed to remove the sorbed strontium through the SrCO₃ mineralization. Through this experiment, the SrCO₃ mineralization-inducing reaction mechanism by microalgae could be observed, and strontium mineral grown up to a micron (μm)-level size could be observed. Unusually, the microalgae excluding Chlorella vulgaris were confirmed to have weak or no SrCO₃ mineralization.

### REFERENCES

[1] Anon., “News from Biominet”, 11 (1988)

[2] Brierley, J. A., et. al., U.S. Pat. No. 4,690,894 (1987)

[3] Kim, Y. H., Yoo, Y. J. & Lee, H. Y. “Characterization of Lead adsorption by Undaria pinnatifida”, Biotechnol. Letters., 17, 3, 345-350 (1995)

Although the present invention has been described in detail with reference to the specific features, it will be apparent to those skilled in the art that this description is only for a preferred embodiment and does not limit the scope of the present invention. Thus, the substantial scope of the present invention will be defined by the appended claims and equivalents thereof.

What is claimed is:

1. A method for removing radionuclides, the method comprising, bring the radionuclides into contact with microalgae.

2. The method of claim 1, wherein the microalgae are species of the genus Chlorella.

3. The method of claim 2, wherein the species of the genus Chlorella is Chlorella sorokinianna or Chlorella vulgaris.

4. The method of claim 1, wherein the radionuclide is cesium (Cesium-137) or strontium (Strontium-90).

5. The method of claim 1, wherein the step of bring the radionuclides into contact with microalgae is performed under conditions of pH 7.5 to pH 9.0.

6. The method of claim 1, wherein the microalgae remove the radionuclides by 10-95%.

7. A composition for removing radionuclides, the composition comprising microalgae.

8. The composition of claim 7, wherein the microalgae are species of the genus Chlorella.

9. The composition of claim 7, wherein the species of the genus Chlorella is Chlorella sorokinianna or Chlorella vulgaris.

10. The composition of claim 7, wherein the radionuclide is cesium (Cesium-137) or strontium (Strontium-90).

11. The composition of claim 7, wherein the removing of the radionuclides is performed under conditions of pH 7.5 to pH 9.0.

12. The composition of claim 7, wherein the microalgae remove the radionuclides by 10-95%.
